(19) United States
(12) Patent Application Publication
(10) Pub. No.: US 2010/0160017 A1
(43) Pub. Date: Jun. 24, 2010

(54) SYSTEM AND METHOD FOR REVEALING A PRIMARY GAME PRIZE VIA SECONDARY GAME PLAY

(76) Inventor: Chris Canard, Fort Worth, TX (US)

Correspondence Address: SMITH MOORE LEATHERWOOD LLP, P.O. BOX 21927, GREENSBORO, NC, 27420, US

(21) Appl. No.: 12/342,642

(22) Filed: Dec. 23, 2008

(51) Int. Cl. A63F 9/24; A63F 13/00

(52) U.S. Cl. 463/16; 463/25; 463/30

(57) ABSTRACT

A system and method for revealing a primary game prize to a participant via the participant's play of a secondary game that is different than the primary game. A primary game engine awards a primary game prize to the participant based on participation in the primary game. The primary game prize is not initially revealed to the participant, thereby making it an unrevealed primary game prize. A secondary game engine controls operation of the secondary game and awards a secondary game prize to the participant based on play of the secondary game. The secondary game prize awarded to the participant is a virtual representation of a portion or all of the unrevealed primary game prize. The notification of the secondary game prize to the participant is a revealing of that portion or all of the unrevealed primary game prize.

The present invention is directed towards a system and method for enabling a person to participate in a primary game in which a prize may be awarded based on the person's participation in the primary game. The awarded prize may not be initially revealed to the person, and the unrevealed primary game prize may be revealed to the person via participation in a secondary game that has a game logic that is separate from the game logic for the primary game.

### BRIEF SUMMARY OF THE PRESENT INVENTION

One embodiment of the present invention is a system for revealing a primary game prize to a participant via the participant's play of a secondary game including a primary game engine that awards a primary game prize to a participant based on the participant's participation in a primary game, and a secondary game engine that awards a secondary game prize to the participant based on the participant's play of a secondary game. The system may not initially reveal the primary game prize to the participant such that the primary game prize is an unrevealed primary game prize. The secondary game prize awarded to the participant by the secondary game engine may be a virtual representation of a portion or all of the unrevealed primary game prize and the system's notification of the secondary game prize to the participant may be a revealing of the respective portion or all of the unrevealed primary game prize.

The system may include a game terminal that is configured to enable the participant to play the secondary game at the game terminal, and the game terminal may be a computer device such as a personal computer, slot machine, arcade machine, gaming device, handheld gaming device, personal digital assistant (PDA), telephone, or cellular phone. The game terminal may include a display screen for displaying the secondary game, a currency acceptor that is configured to accept currency from the participant, a currency dispenser that is configured to dispense currency to the participant, and a card reader and writer that is configured to read and write to cards, such as cards having a magnetic stripe or smart cards. The game terminal may be networked with or operatively connected to at least one server that houses at least one of the primary game engine and the secondary game engine. The game terminal may also include the primary game engine and the secondary game engine.

The primary game engine may include a primary game logic that controls operation of the primary game, the secondary game engine may include a secondary game logic that controls operation of the secondary game, and the primary game logic may be the same as or different than the secondary game logic. The primary game may be different than the secondary game. The primary game engine may award game entries to the participant for use in playing the secondary game. The number of game entries awarded to the participant by the primary game engine may be relative to the primary game prize awarded to the participant from participating in the primary game. The primary game may be a game such as a sweepstakes, random game of chance, or lottery contest. The primary game engine may award the participant with at least one additional primary game prize based on the participant's participation in the primary game, and the primary game engine may sum the value of the primary game prizes awarded to the participant to create an unrevealed primary game prize balance. The system may store the primary game prize that is awarded to the participant. The primary game prize may have monetary value or a credit value.

The system may be configured to reveal some or all of the participant's unrevealed primary game prize upon request by the participant. The secondary game engine may controls operations of several different secondary games. The secondary game engine may comprise separate logic for controlling each of the different secondary games. The secondary game may be an electronic or electromechanical game.

The system may notify the participant of the number of game entries available for use in playing the secondary game and enable the participant to select a portion or all of his available game entries to use in playing the secondary game. The secondary game prize awarded to the participant may be relative to the number of game entries used by the participant to play the secondary game. The secondary game engine may award the participant with at least one additional secondary game prize and sum the awarded secondary game prizes to create a secondary game prize balance. The secondary game prize balance may not exceed the sum of primary game prizes awarded to the participant. The secondary game engine may award the participant a bonus secondary game prize if the participant runs out of game entries for use in playing the secondary game before the secondary game prize balance equals the primary game prize balance. The bonus secondary game prize may be equal to the difference between the primary game prize balance and the secondary game prize balance at the time the participant runs out of game entries for use in playing the secondary game. The system may reveal all of the primary game prize balance when the participant runs out of game entries for use in playing the secondary game.

The system may be configured to store the number of game entries available for use by the participant to enable the participant to access the system at a subsequent time and play the secondary game using the participant's available game entries. The system may be configured to store the unrevealed primary game prize balance, or any portion thereof, to enable the participant to access the system at a subsequent time and play the secondary game to reveal the unrevealed primary game prize balance. The system may be configured to issue the revealed primary game prize to the participant such that the participant takes possession of the revealed primary game prize. The system may be configured to store the revealed primary game prize, or any portion thereof, to enable the participant to access the system at a subsequent time and take possession of the revealed primary game prize, or portion thereof.

The participant may initiate play of the primary game by paying consideration for a product or service, or making a charitable donation. The display screen on the game terminal may be a touch screen that enables the participant to input information into the system while playing the secondary game.

The participant's play of the secondary game may include several secondary game transactions. The secondary game prize may be awarded to the participant based on the participant's engagement in at least one secondary game transaction. At least one additional secondary game prize may be awarded to the participant based on the participant's engagement in at least one additional secondary game transaction. The system may notify the participant of any awarded secondary game prize after each engagement in a secondary game transaction by the participant so as to incrementally reveal the unrevealed primary game prize.

An additional embodiment of the present invention may include a method of revealing a primary game prize to a participant via the participant's play of a secondary game including the steps of enabling a participant to participate in a primary game, awarding a primary game prize to the participant based on the participant's participation in the primary game, initially not revealing the primary game prize to the participant such that the primary game prize is an unrevealed primary game prize, enabling the participant to play a secondary game, awarding a secondary game prize to the participant based on the participant's play of the secondary game, the secondary game prize being a virtual representation of a portion or all of the primary game prize, and notifying the participant of the awarded secondary game prize, such notification being a revealing of the respective portion or all of the unrevealed primary game prize. The method may further include the step of awarding game entries to the participant for use in playing the secondary game.

The method may further include the steps of awarding the participant with at least one additional primary game prize based on the participant's participation in the primary game, and summing the value of the primary game prizes awarded to the participant to create an unrevealed primary game prize balance. The method may also include the steps of storing the primary game prize that is awarded to the participant, revealing some or all of the participant's unrevealed primary game prize upon request by the participant, notifying the participant of the number of game entries available for use in playing the secondary game, and enabling the participant to select a portion or all of his available game entries to use in playing the secondary game.

The method may include the steps of awarding the participant with at least one additional secondary game prize, and summing the awarded secondary game prizes to create a secondary game prize balance. The method may also include the steps of awarding the participant a bonus secondary game prize if the participant runs out of game entries for use in playing the secondary game before the secondary game prize balance equals the primary game prize balance and revealing all of the primary game prize balance when the participant runs out of game entries for use in playing the secondary game.

The method may include storing the number of game entries available for use by the participant to enable the participant to access the system at a subsequent time and play the secondary game using the participant's available game entries. The method may also include storing the unrevealed primary game prize balance, or any portion thereof, to enable the participant to access the system at a subsequent time and play the secondary game to reveal the unrevealed primary game prize balance and issuing the revealed primary game prize to the participant such that the participant takes possession of the revealed primary game prize.

The method may include storing the revealed primary game prize, or any portion thereof, to enable the participant to access the system at a subsequent time and take possession of the revealed primary game prize, or portion thereof.

The method of the present invention may enable the participant to engage in several secondary game transactions while playing the secondary game, award the secondary game prize to the participant based on the participant's engagement in at least one secondary game transaction, award at least one additional secondary game prize to the participant based on the participant's engagement in at least one additional secondary game transaction, and notify the participant of any awarded secondary game prize after each engagement in a secondary game transaction by the participant so as to incrementally reveal the unrevealed primary game prize balance.

A further embodiment of the present invention may include a method of revealing a primary game prize to a participant via the participant's play of a secondary game including the steps of initially not revealing a primary game prize to a participant such that the primary game prize is an unrevealed primary game prize, enabling the participant to play a secondary game, awarding a secondary game prize to the participant based on the participant's play of the secondary game, the secondary game prize being a virtual representation of a portion or all of the primary game prize, and notifying the participant of the awarded secondary game prize, such notification being a revealing of the respective portion or all of the unrevealed primary game prize. The method may include the step of enabling the participant to participate in a primary game in order to be awarded the primary game prize.

Yet another embodiment of the present invention may include a method in a computer system for revealing a primary game prize to a participant via the participant's play of a secondary game, the method including the steps of initially not revealing a primary game prize to a participant such that the primary game prize is an unrevealed primary game prize, providing a logic for controlling a the participant to play a secondary game, awarding a secondary game prize to the participant based on the participant's play of the secondary game, the secondary game prize being a virtual representation of a portion or all of the primary game prize, and notifying the participant of the awarded secondary game prize, such notification being a revealing of the respective portion or all of the unrevealed primary game prize.

### BRIEF DESCRIPTION OF THE FIGURES

FIG. 1 is a block diagram of an example of an embodiment of the system of the present invention; and

FIGS. 2A-2B are a flowchart of an example of an embodiment of the method of the present invention.

### DETAILED DESCRIPTION OF THE INVENTION

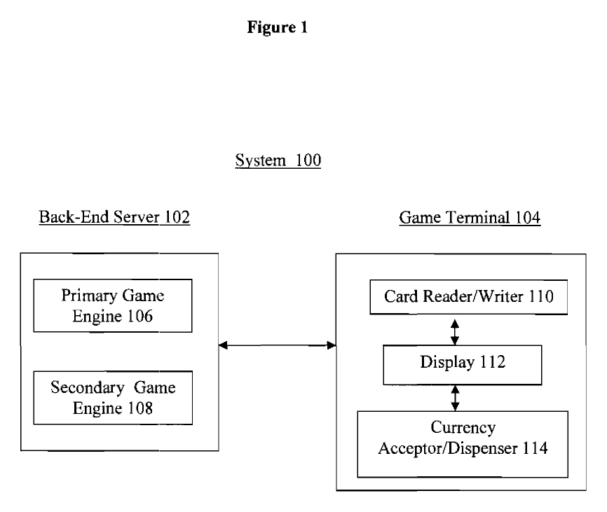

As shown in FIG. 1, the system 100 of the present invention may include a primary game engine 106 and a secondary game engine 108. The primary game engine 106 and secondary game engine 108 may be part of a back-end server or servers 102 that are operatively connected to or networked with one or more game terminals 104. For example, the game terminals 104 may be operatively connected to the back-end server or servers 102 via the Internet. It should be understood, however, that such primary and secondary game engines 106, 108 may be integrated within a stand alone game terminal 104.

The system 100 is configured to enable a person (also referred to herein as a participant) to participate in a primary game in order to win a primary game prize or prizes. It should be understood that the primary game in which the person participates to receive the primary game prizes may be any type of game or contest, such as a sweepstakes in which there are a finite number of prizes, a random game of chance, a finite game, a pull lottery contest, or any other type of game or contest. The primary game engine 106 may provide the underlying logic for awarding the primary game prizes to the participant.

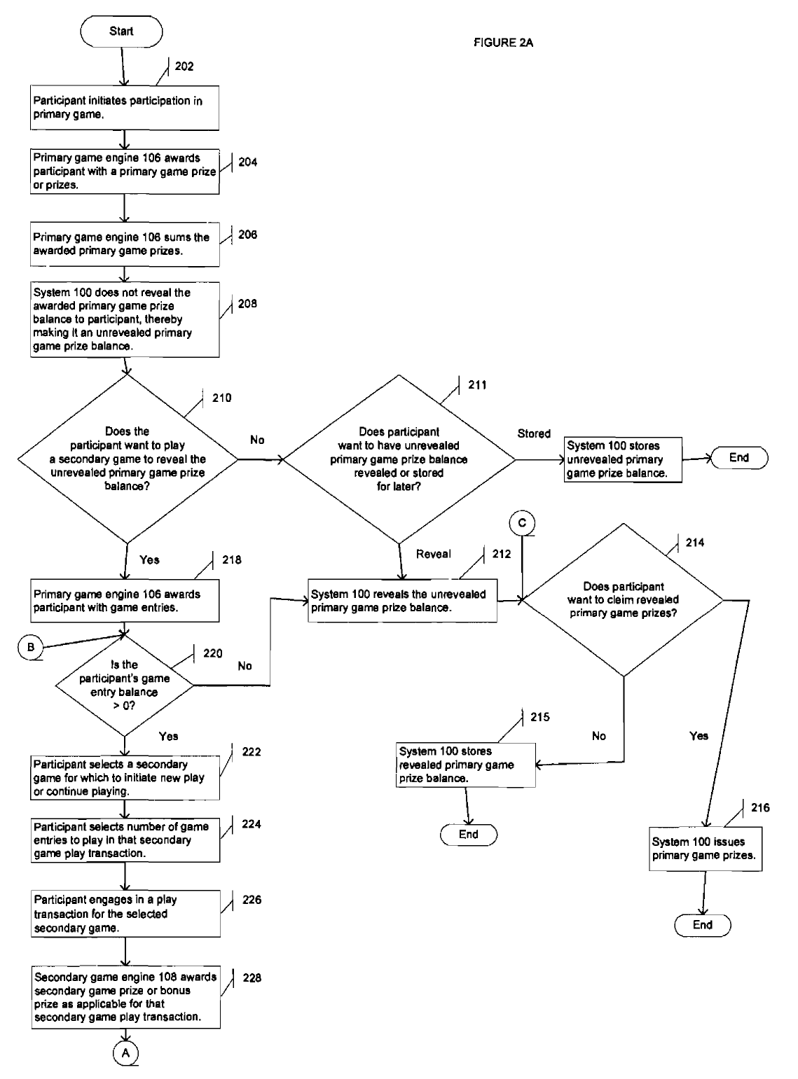

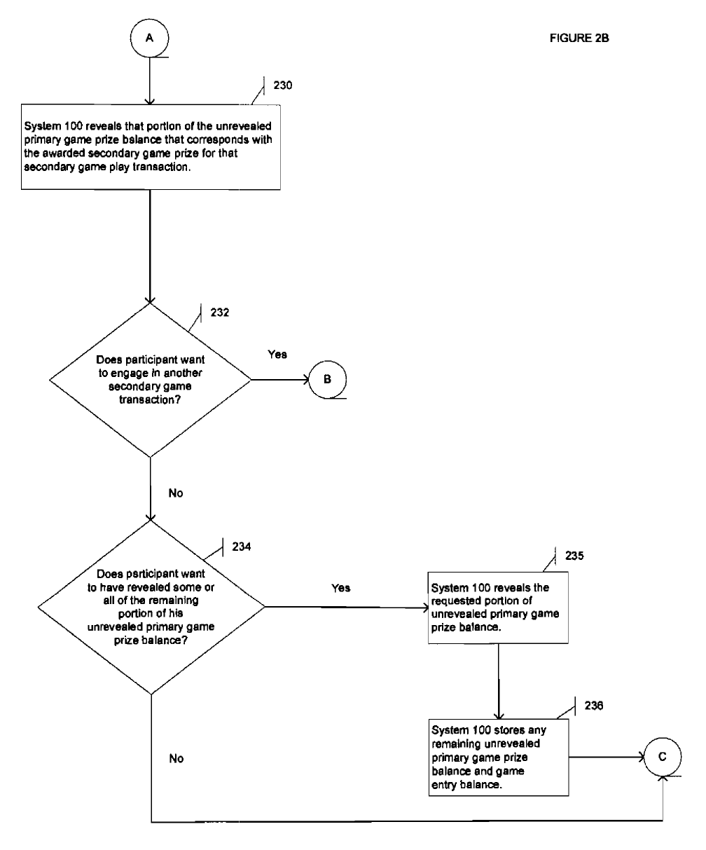

For example, if the primary game is a sweepstakes, the participant may receive free entries into the sweepstakes upon payment for a product, such as a prepaid phone card, or donation to charitable organization. As shown in FIG. 2, the participant may initiate participation in the primary game at the game terminal 104 (step 202) by using the terminal's display 112 (which may be a touch-screen display), currency acceptor/dispenser 114, and card reader/writer 110. It should be understood that the game terminal 104 may also receive user input via a button panel, keyboard, mouse, voice command, or the like. The number of promotional sweepstake entries given to the participant may be related to the amount of consideration paid by the participant for the product or the donation, and may be determined by the logic provided by the primary game engine 106. The primary game engine 106 may also select, from the finite number of prizes available in the sweepstakes, the primary game prize or prizes that are awarded to the participant based on the participant's entry into the sweepstakes (step 204). Similarly, if the primary game is a random game of chance, the primary game engine 106 may provide the logic for awarding the primary game prize or prizes to the participant upon the purchase of an entry into the game of chance (step 204).

Regardless of the type of primary game or contest in which the person participates, the primary game engine 106 may determine the primary game prizes that are awarded to the participant (step 204), as explained above, and may sum the awarded primary game prize values to create an unrevealed primary game prize balance (step 206). It should be understood that even though the participant may be awarded the primary game prizes by the primary game engine 106 based on participating in the primary game, the value of the primary game prizes may not be initially revealed to the participant, thereby making it an “unrevealed” primary game prize balance (step 208). The unrevealed primary game prize balance may be expressed in terms of monetary value, prize credits, or otherwise. If the primary game prize balance is expressed in monetary value, for example, and the participant was awarded prizes of $5 and $3 from its participation in the primary game, the unrevealed primary game prize balance is $8.

When the primary game engine 106 sums the participant's primary game prize balance (step 206) to create the unrevealed primary game prize balance (step 208), the participant may be given the option of participating in a secondary transaction (or set of transactions) that may incrementally reveal the unrevealed primary game prize balance to the participant, such as by playing a secondary game (step 210). If the participant chooses to not play a secondary game, the participant may be given the option of having the unrevealed primary game prize balance revealed to him all at one time or keeping the unrevealed primary game prize balance unrevealed (step 211). If the participant chooses to have the unrevealed primary game balance revealed to him all at once, the system 100 may reveal the entire primary game prize balance (step 212) and the participant may proceed with claiming the primary game prizes (steps 214 and 216), as explained in more detail below. On the other hand, if the participant chooses to keep the unrevealed primary game balance unrevealed, such unrevealed primary game balance may be stored in the system 100 and/or on an external storage data device such as a smart card or a card with a magnetic stripe (step 213). This may enable the participant to access the system 100 at a later time and either have the unrevealed primary prize balance revealed all at once or participate in a secondary game that may incrementally reveal the primary game prize balance to the participant.

If the participant selects the option of playing a secondary game (step 210), the primary game engine 106 may award the participant a number of promotional game entries for use in playing the secondary game that may reveal the already awarded, yet unrevealed, primary game prize balance (step 218). The number of game entries awarded to the participant by the primary game engine 106 may be related to the number or value of the primary game prizes that were awarded to the participant from participation in the primary game. For example, the primary game engine 106 may be configured to award the participant a predetermined number of game entries for every $1 in primary game prizes that were awarded to the participant from participating in the primary game. The system 100 may track the sum of game entries available to the user, which is referred to herein as the game entry balance.

Referring again to FIG. 2, the system 100 may determine whether the participant has an available balance of game entries (step 220), and, if so, allow the participant to select a secondary game to play from a plurality of different types of secondary games (step 222). Each secondary game that is available for play may have its own individual rules, prize tables, graphics, player methods, and player experiences, and each of which may be controlled by separate logic supplied by the secondary game engine 108. Examples of secondary games may include electronic and electromechanical games such as poker, keno, eight liners, Uno, spades, whack-a-mole, Zuma, and other types of video games, etc.

When the participant selects a secondary game to play (step 222), the participant may use some or all of his promotional game entries awarded by the primary game engine 106 to play the secondary game (step 224). The system 100 may notify the participant of his game entry balance via the display 112 on the game terminal 104 so the participant knows how many game entries are available for him to play. For example, if the participant has a game entry balance of twenty entries, the participant may opt to use five entries in his first play event of a secondary game and then use the remaining fifteen game entries in a second play event of the secondary game. Alternatively, the participant may opt to use five game entries in the first play event of the secondary game, five entries in the second play event, and five entries in the third play event. The participant may have the option of deciding how many game entries to use in each secondary game transaction so long as he has a balance of available game entries (step 220).

When the participant uses some or all of his available game entries to participate in a play event of the selected secondary game (step 226), the secondary game engine 108 may award a secondary game prize based on logic in the secondary game engine 108 (step 228). For example, the secondary game engine 108 may take into consideration the number of game entries used by the participant for that particular play transaction in determining the value of the secondary game prize to be awarded for that play transaction. Because the participant has already been awarded the primary game prizes from participation in the primary game (even if the value of those primary game prizes has not yet been fully revealed to the participant), the secondary game prize may be a virtual or representative prize that the secondary game engine 108 shows as being awarded to the participant to enhance enjoyment of playing the secondary game. Particularly, the virtual secondary game prizes may be representative of some or all of the unrevealed primary game prize balance, and, therefore, may reflect the revealed portion of the primary game prize balance (step 230). Thus, the system 100 may be configured so that it does not award the with participant more value in secondary, virtual game prizes than the value of the primary game prizes that have already been awarded to the participant, as shown below.

Table 1 below gives an example of secondary game play for a participant that was awarded a total of $50 in primary game prizes from participation in a primary game, such as a sweepstakes. The logic in the primary game engine 106 determined that the participant was entitled to 600 game entries based on the number or value of primary game prizes that were awarded to the participant. None of the $50 primary game prize balance was revealed to participant prior to secondary game play and, therefore, was an unrevealed primary game prize balance. The unrevealed primary game prize was incrementally revealed to participant via secondary game play as shown in the Table.

TABLE 1

| Unrevealed | | | | | |
|---|---|---|---|---|---|
| primary | | Secondary | Revealed | | |
| game prize | | Game | Primary | Unrevealed | |
| balance = $50 | Game | Prize | Game | Primary | Game |
| Game entry | Entries | for that | Prize | Game Prize | Entry |
| balance = 600 | Played | Play | Balance | Balance | Balance |
| Secondary | 100 | $15 | $15 | $35 | 500 |
| Game | | | | | |
| Play 1 | | | | | |
| Secondary | 300 | $10 | $25 | $25 | 200 |
| Game | | | | | |
| Play 2 | | | | | |
| Secondary | 200 | $20 | $45 | $5 | 0 |
| Game | | | | | |
| Play 3 | | | | | |
| Post-Play | | $5 | $50 | $0 | 0 |
| Secondary | | | | | |
| Game Prize | | | | | |
| Bonus | | | | | |

As shown in the example in Table 1, the participant may run out of game entries prior to receiving enough in secondary, virtual game prizes to total the $50 primary game prize. Specifically, there was $5 in unrevealed primary game prizes still remaining after all the game entries were played. This may occur at times when, in order for the secondary game to logically function in a manner that is familiar to the user (which logic is provided by the secondary game engine 108), the increments of secondary game prizes awarded may not necessarily add up to the total value of the primary game prize balance. Therefore, the system 100 may be configured to award a bonus secondary game prize after the participant has used all of his game entries and ended play of the secondary game (step 228). The bonus secondary game prize may be for the remainder of the unrevealed primary game prize balance so that the total of secondary, virtual game prizes awarded equals the total value of the primary game prize and there is no primary game prize balance that is yet to be revealed (step 230). In the example in Table 1, the remainder of the unrevealed primary game balance was $5 after all the participant's game entries had been played. Therefore, $5 was awarded to the participant as a bonus secondary game prize.

Referring again to FIG. 2, the participant may opt to continue playing the secondary game (step 232) until he has consumed all of his game entries and has none left for secondary game play (step 220). When the participant has consumed all of his game entries, the system 100 may automatically reveal the primary game prize balance (step 212).

The participant may also end his secondary game play at any time (even prior to consuming all of his game entries) and request that some or all of his remaining unrevealed primary game prize balance be revealed (step 234). The system 100 may then reveal the requested portion of the unrevealed primary game prize balance (step 235), if any, and store any remaining unrevealed primary game prize balance and game entry balance in the system 100 and/or on an external storage device such as a smart card or a card with a magnetic stripe (step 236). The system 100 may also proceed with enabling the participant to claim his revealed primary game prizes (steps 214 and 216). On the other hand, if the participant chooses to not have revealed his remaining unrevealed primary game prize balance (step 234), the system 100 may store the remaining unrevealed primary game prize balance and game entry balance in the system 100 and/or on an external storage device (step 236), and enable the participant to claim his already revealed primary game prizes (steps 214 and 216).

Any storage of the participant's unrevealed primary game prize balance and game entry balance in the system 100 and/or on an external storage device may enable the participant to access the system 100 at any subsequent time to continue playing the same secondary game or a different secondary game utilizing his game entry balance. Further, the participant may initiate entry into an additional primary game at any time in order to receive additional primary game prizes and corresponding game entries, which may be added to the participant's former primary game prize balance and game entry balance.

At any time when the participant's primary game prize balance has been partially or fully revealed, the participant may choose to claim and take possession of some or all of his already awarded primary game prizes (step 214). In the scenario referenced in Table 1 above, the participant may claim and take possession of his entire $50 primary game prize. A system operator may be utilized to issue the claimed primary game prizes to the participant, whether it is in monetary value or otherwise (step 216). Alternatively, the participant may take possession of the claimed primary game prizes at the game terminal 104 via use of a currency dispenser 114 and/or device for writing monetary value to a card 110, such as a gift card (step 216). If the participant chooses to not claim his revealed primary game prizes (step 214), the system 100 may store the revealed primary game prize balance in this system 100 and/or an external storage device such as a smart card or a card with a magnetic stripe (step 215). This enables the participant to access the system 100 at a later time and claim his revealed primary game prizes.

The foregoing system 100 and method provides a fun way for a participant to have his primary game prizes revealed to him through secondary game play, and the user may experience playing the secondary game in a manner that is familiar to him. Thus, the present invention uniquely integrates a primary game with one or more secondary games, each secondary game having its own game logic.

It will be appreciated by those skilled in the game terminal 104 of the present invention may be any suitable, networked or stand-alone, computer device, and any such suitable computer device may be adapted for, without limitation, any one of a specialized client application, a web browser, or a specialized client application and a web browser. Some examples of a suitable computer device include, without limitation, any one of a personal computer, slot machine, arcade machine, gaming device, handheld gaming device, personal digital assistant (PDA), telephone, cellular phone, or any combination of any of the preceding. Examples of a suitable personal computer include, without limitation, any one of a desktop computer, a notebook computer, or any combination of any of the preceding.

What is claimed is:

1. A system for revealing a primary game prize to a participant via the participant's play of a secondary game comprising:
a primary game engine that awards a primary game prize to a participant based on the participant's participation in a primary game; and
a secondary game engine that awards a secondary game prize to the participant based on the participant's play of a secondary game;
wherein the system does not initially reveal the primary game prize to the participant such that the primary game prize is an unrevealed primary game prize;
wherein the secondary game prize awarded to the participant by the secondary game engine is a virtual representation of a portion or all of the unrevealed primary game prize; and
wherein the system's notification of the secondary game prize to the participant is a revealing of the respective portion or all of the unrevealed primary game prize.

2. The system of claim 1 further comprising a game terminal that is configured to enable the participant to play the secondary game at the game terminal.

3. The system of claim 2 wherein the game terminal is a computer device selected from the group consisting of a personal computer, slot machine, arcade machine, gaming device, handheld gaming device, personal digital assistant (PDA), telephone, and cellular phone.

4. The system of claim 2 wherein the game terminal comprises:
a display screen for displaying the secondary game;
a currency acceptor that is configured to accept currency from the participant;
a currency dispenser that is configured to dispense currency to the participant; and
a card reader and writer that is configured to read and write to cards.

5. The system of claim 1 further comprising at least one server that houses at least one of the primary game engine and the secondary game engine.

6. The system of claim 1 further comprising a game terminal that is that is:
configured to enable the participant to play the secondary game at the game terminal; and
networked with or operatively connected to at least one server that houses at least one of the primary game engine and the secondary game engine.

7. The system of claim 1 further comprising a game terminal that is configured to enable the participant to play the secondary game at the game terminal, and comprises the primary game engine and the secondary game engine.

8. The system of claim 1 wherein:
the primary game engine comprises a primary game logic that controls operation of the primary game;
the secondary game engine comprises a secondary game logic that controls operation of the secondary game; and
the primary game logic is the same as or different than the secondary game logic.

9. The system of claim 1 wherein the primary game is different than the secondary game.

10. The system of claim 1 wherein the primary game engine awards game entries to the participant for use in playing the secondary game.

11. The system of claim 10 wherein the number of game entries awarded to the participant by the primary game engine is relative to the primary game prize awarded to the participant from participating in the primary game.

12. The system of claim 1 wherein the primary game is a game selected from the group consisting of a sweepstakes, random game of chance, and lottery contest.

13. The system of claim 1 wherein the primary game engine awards the participant with at least one additional primary game prize based on the participant's participation in the primary game, and the primary game engine sums the value of the primary game prizes awarded to the participant to create an unrevealed primary game prize balance.

14. The system of claim 1 wherein the system is configured to store the primary game prize that is awarded to the participant.

15. The system of claim 1 wherein the primary game prize has a value selected from the group consisting of a monetary value and a credit value.

16. The system of claim 1 wherein the system is configured to reveal some or all of the participant's unrevealed primary game prize upon request by the participant.

17. The system of claim 1 wherein the secondary game engine controls operations of a plurality of different secondary games.

18. The system of claim 17 wherein the secondary game engine comprises separate logic for controlling each of the different secondary games.

19. The system of claim 1 wherein the secondary game is an electronic or electromechanical game.

20. The system of claim 10 wherein the system notifies the participant of the number of game entries available for use in playing the secondary game.

21. The system of claim 10 wherein the system enables the participant to select a portion or all of his available game entries to use in playing the secondary game.

22. The system of claim 21 wherein the secondary game prize awarded to the participant is relative to the number of game entries used by the participant to play the secondary game.

23. The system of claim 13 wherein the secondary game engine awards the participant with at least one additional secondary game prize and sums the awarded secondary game prizes to create a secondary game prize balance.

24. The system of claim 23 wherein the secondary game prize balance does not exceed the sum of primary game prizes awarded to the participant.

25. The system of claim 23 wherein the secondary game engine awards the participant a bonus secondary game prize if the participant runs out of game entries for use in playing the secondary game before the secondary game prize balance equals the primary game prize balance.

26. The system of claim 25 wherein the bonus secondary game prize is equal to the difference between the primary game prize balance and the secondary game prize balance at the time the participant runs out of game entries for use in playing the secondary game.

27. The system of claim 10 wherein the system reveals all of the primary game prize balance when the participant runs out of game entries for use in playing the secondary game.

28. The system of claim 10 wherein the system is configured to store the number of game entries available for use by the participant to enable the participant to access the system at a subsequent time and play the secondary game using the participant's available game entries.

29. The system of claim 13 wherein the system is configured to store the unrevealed primary game prize balance, or any portion thereof, to enable the participant to access the system at a subsequent time and play the secondary game to reveal the unrevealed primary game prize balance.

30. The system of claim 1 wherein the system is configured to issue the revealed primary game prize to the participant such that the participant takes possession of the revealed primary game prize.

31. The system of claim 1 wherein the system is configured to store the revealed primary game prize, or any portion thereof, to enable the participant to access the system at a subsequent time and take possession of the revealed primary game prize, or portion thereof.

32. The system of claim 1 wherein the participant initiates play of the primary game by paying consideration for a product or service, or making a charitable donation.

33. The system of claim 4 wherein the display screen is a touch screen that enables the participant to input information into the system while playing the secondary game.

34. The system of claim 1 wherein the participant's play of the secondary game comprises a plurality of secondary game transactions.

35. The system of claim 34 wherein the secondary game prize is awarded to the participant based on the participant's engagement in at least one secondary game transaction.

36. The system of claim 35 wherein at least one additional secondary game prize is awarded to the participant based on the participant's engagement in at least one additional secondary game transaction.

37. The system of claim 36 wherein the system notifies the participant of any awarded secondary game prize after each engagement in a secondary game transaction by the participant so as to incrementally reveal the unrevealed primary game prize.

38. A method of revealing a primary game prize to a participant via the participant's play of a secondary game comprising the steps of:
enabling a participant to participate in a primary game;
awarding a primary game prize to the participant based on the participant's participation in the primary game;
initially not revealing the primary game prize to the participant such that the primary game prize is an unrevealed primary game prize;
enabling the participant to play a secondary game;
awarding a secondary game prize to the participant based on the participant's play of the secondary game, the secondary game prize being a virtual representation of a portion or all of the primary game prize; and
notifying the participant of the awarded secondary game prize, such notification being a revealing of the respective portion or all of the unrevealed primary game prize.

39. The method of claim 38 wherein the primary game is the same as or different than the secondary game.

40. The method of claim 39 further comprising the step of awarding game entries to the participant for use in playing the secondary game.

41. The method of claim 40 wherein the number of game entries awarded to the participant is relative to the primary game prize awarded to the participant from participating in the primary game.

42. The method of claim 38 wherein the primary game is a game selected from the group consisting of a sweepstakes, random game of chance, and lottery contest.

43. The method of claim 38 further comprising the steps of:
awarding the participant with at least one additional primary game prize based on the participant's participation in the primary game; and
summing the value of the primary game prizes awarded to the participant to create an unrevealed primary game prize balance.

44. The method of claim 38 further comprising the step of storing the primary game prize that is awarded to the participant.

45. The method of claim 38 further comprising the step of revealing some or all of the participant's unrevealed primary game prize upon request by the participant.

46. The method of claim 38 wherein the secondary game is an electronic or electromechanical game.

47. The method of claim 40 further comprising the step of notifying the participant of the number of game entries available for use in playing the secondary game.

48. The method of claim 40 further comprising the step of enabling the participant to select a portion or all of his available game entries to use in playing the secondary game.

49. The method of claim 48 wherein the secondary game prize awarded to the participant is relative to the number of game entries used by the participant to play the secondary game.

50. The method of claim 38 further comprising the steps of:
awarding the participant with at least one additional secondary game prize; and
summing the awarded secondary game prizes to create a secondary game prize balance.

51. The method of claim 50 wherein the secondary game prize balance does not exceed the sum of primary game prizes awarded to the participant.

52. The method of claim 38 further comprising the step of awarding the participant a bonus secondary game prize if the participant runs out of game entries for use in playing the secondary game before the secondary game prize balance equals the primary game prize balance.

53. The method of claim 52 wherein the bonus secondary game prize is equal to the difference between the primary game prize balance and the secondary game prize balance at the time the participant runs out of game entries for use in playing the secondary game.

54. The method of claim 38 further comprising the step of revealing all of the primary game prize balance when the participant runs out of game entries for use in playing the secondary game.

55. The method of claim 40 further comprising the step of storing the number of game entries available for use by the participant to enable the participant to access the system at a subsequent time and play the secondary game using the participant's available game entries.

56. The method of claim 43 further comprising the step of storing the unrevealed primary game prize balance, or any portion thereof, to enable the participant to access the system at a subsequent time and play the secondary game to reveal the unrevealed primary game prize balance.

57. The method of claim 38 further comprising the step of issuing the revealed primary game prize to the participant such that the participant takes possession of the revealed primary game prize.

58. The method of claim 38 further comprising the step of storing the revealed primary game prize, or any portion thereof, to enable the participant to access the system at a subsequent time and take possession of the revealed primary game prize, or portion thereof.

59. The method of claim 38 wherein the participant initiates participation in the primary game by paying consideration for a product or service, or making a charitable donation.

60. The method of claim 38 further comprising the step of enabling the participant to engage in a plurality of secondary game transactions while playing the secondary game.

61. The method of claim 60 further comprising the step awarding the secondary game prize to the participant based on the participant's engagement in at least one secondary game transaction.

62. The method of claim 61 further comprising the step of awarding at least one additional secondary game prize to the participant based on the participant's engagement in at least one additional secondary game transaction.

63. The method of claim 60 further comprising the step of notifying the participant of any awarded secondary game prize after each engagement in a secondary game transaction by the participant so as to incrementally reveal the unrevealed primary game prize balance.

64. A method of revealing a primary game prize to a participant via the participant's play of a secondary game comprising the steps of:
initially not revealing a primary game prize to a participant such that the primary game prize is an unrevealed primary game prize;
enabling the participant to play a secondary game;
awarding a secondary game prize to the participant based on the participant's play of the secondary game, the secondary game prize being a virtual representation of a portion or all of the primary game prize; and
notifying the participant of the awarded secondary game prize, such notification being a revealing of the respective portion or all of the unrevealed primary game prize.

65. The method of claim 64 further comprising the step of enabling the participant to participate in a primary game in order to be awarded the primary game prize.

66. A method in a computer system for revealing a primary game prize to a participant via the participant's play of a secondary game, the method comprising the steps of:
initially not revealing a primary game prize to a participant such that the primary game prize is an unrevealed primary game prize;
providing a logic for controlling a the participant to play a secondary game;
awarding a secondary game prize to the participant based on the participant's play of the secondary game, the secondary game prize being a virtual representation of a portion or all of the primary game prize; and
notifying the participant of the awarded secondary game prize, such notification being a revealing of the respective portion or all of the unrevealed primary game prize.
